(19) United States
(12) Patent Application Publication
(10) Pub. No.: US 2019/0280321 A1
(43) Pub. Date: Sep. 12, 2019

(54) MEMBRANE/ELECTRODE ASSEMBLY COMPRISING A HIGHLY CAPACITIVE CATALYTIC ANODE

(71) Applicant: COMMISSARIAT A L'ENERGIE ATOMIQUE ET AUX ENERGIES ALTERNATIVES, Paris (FR)

(72) Inventors: Marco BOLLOLI, Grenoble (FR); Benjamin DECOOPMAN, Neuve-Chapelle (FR); Sebastien ROSINI, Grenoble (FR); Remi VINCENT, Grenoble (FR)

(73) Assignee: COMMISSARIAT A L'ENERGIE ATOMIQUE ET AUX ENERGIES ALTERNATIVES, Paris (FR)

(21) Appl. No.: 16/315,041

(22) PCT Filed: Jul. 3, 2017
(86) PCT No.: PCT/FR2017/051806

§ 371 Date: Jan. 3, 2019

(30) Foreign Application Priority Data
Jul. 6, 2016 (FR) 1656471

(51) Int. Cl. H01M 8/1004; H01M 4/86; H01M 4/88; H01M 4/92; H01M 8/0243; H01M 8/0258

(52) U.S. Cl. CPC H01M 8/1004; H01M 4/8657; H01M 4/8668; H01M 4/8673; H01M 2008/1095; H01M 4/926; H01M 8/0243; H01M 8/0258; H01M 4/8807

(57) ABSTRACT

The invention relates to a fuel cell comprising a membrane/electrode assembly (14), that includes:
a proton exchange membrane (2);
an anode (31) which is in contact with a first surface of the membrane and which contains a mixture including a proton conducting polymer and platinum supported on carbon powder;
said mixture further includes additional carbon which does not support any catalyst and which has a minimum specific surface area BET of 200 m²/g.

The membrane/electrode assembly (14) has a first active region (21) that is covered by the anode (31), and a first joining region (22) that is not covered by the anode (31).

The invention relates to fuel cells, and more particularly fuel cells including bipolar plates between which a membrane/electrode assembly with proton exchange membrane is arranged.

Fuel cells are notably envisaged as an energy source for motor vehicles produced on a large scale in the future or as auxiliary energy sources in aeronautics. A fuel cell is an electrochemical device that converts chemical energy directly into electrical energy. A fuel cell comprises a stack of several cells in series. Each cell typically generates a voltage of the order of 1 V, and stacking them makes it possible to generate a supply voltage of a higher level, for example of the order of a hundred volts.

Among the known types of fuel cells, we may notably mention the proton exchange membrane (PEM) fuel cell, operating at low temperature. Fuel cells of this kind have particularly advantageous properties of compactness. Each cell comprises an electrolytic membrane only allowing protons to pass, and not electrons. The membrane has a negative electrode on a first face and a positive electrode on a second face, consisting of platinum, carbon and proton conducting polymer binder, to form a membrane/electrode assembly (MEA). The electrodes are also in contact, on their second face, with porous supports made of carbon, which allow collection of the current, passage of reactive gases, and release of the water produced. Finally, the membrane generally comprises, at its periphery, two reinforcements fixed on its respective faces.

At the anode, dihydrogen used as fuel is oxidized to produce protons that pass through the membrane. The membrane thus forms a proton conductor. The electrons produced by this reaction migrate to a flow plate, and then pass through an electric circuit outside the cell to form an electric current. At the cathode, oxygen is reduced and reacts with the protons to form water.

The fuel cell may comprise several so-called bipolar plates, for example made of metal, stacked on top of one another. The membrane is arranged between two bipolar plates. The bipolar plates may comprise flow channels and holes for continuously guiding the reactants and the products to/from the membrane. The bipolar plates also comprise flow channels for guiding liquid coolant that removes the heat produced. The reaction products and the unreactive species are evacuated by entrainment by the flow to the outlet of the networks of flow channels. The flow channels of the various flows are separated notably by the bipolar plates. The bipolar plates are also electrically conducting for collecting electrons generated at the anode. The bipolar plates also have a mechanical function of transmitting the forces clamping the stack, which is necessary for the quality of electrical contact. Electron conduction takes place through the bipolar plates, ionic conduction being obtained through the membrane. Gas diffusion layers are interposed between the electrodes and the bipolar plates and are in contact with the bipolar plates.

Some designs of bipolar plates use homogenization zones for connecting inlet and outlet collectors to the various flow channels of the bipolar plates. Such homogenization zones generally lack electrodes. The reactants are brought into contact with the electrodes from inlet collectors and the products are evacuated from outlet collectors connected to the various flow channels. The inlet collectors and the outlet collectors generally pass through the full thickness of the stack.

Fuel cells are generally limited by a maximum operating current that they can supply to an electrical load. This maximum current is a parameter in the dimensioning of the fuel cell. This parameter thus has an influence on the overall dimensions, weight and cost of the fuel cell. Depending on the use of the fuel cell, management of transient peaks of current surges may thus require excessive dimensioning relative to the average usage current of the fuel cell.

Moreover, certain phenomena may lead to degradation of the performance of the fuel cell during its operation or owing to irreversible degradation of materials forming the cathode. Among the solutions proposed for maintaining the performance of a fuel cell, document FR3006114 notably proposes periodically interrupting the supply of the combustive, inducing transient depolarization.

However, stop/start cycles may constitute a source of degradation of the membrane/electrode assembly (MEA): notably, injection of hydrogen on starting combined with presence of air at the anode induces division into an active zone and a passive zone. Operation is normal in the active zone, but inverse currents are generated in the passive part, which causes corrosion of a support material of the cathode, especially when it is of carbon nanomaterial. A similar phenomenon occurs on stopping, more particularly if oxygen or air is injected into the fuel cell. It is therefore important to reduce the extent of depolarization of the cell during these events.

To do this, document U.S. Pat. No. 6,024,848 proposed including an additional capacitance in the fuel cell, so as notably to be able to supply a transient peak current, or to be able to supply a current if there is shortage of fuel. This document describes the provision of additional layers, structured as separate hydrophobic and hydrophilic zones, on the gas diffusion layers, made with a specific combination of materials. Inside these layers, the hydrophobic zones allow passage of the gas and the hydrophilic zones make it possible to ensure transport of water, and supply the additional capacitance.

This configuration does not mean that the nonfaradaic capacitance of the electrodes can be dispensed with entirely. In fact, during discharge of the capacitances following a shortage of fuel, the charges present at one electrode are transferred to the other electrode. The capacitances must therefore be identical at the anode and at the cathode to optimize their use. Now, the catalyst loading is normally higher at the cathode level than at the anode level, as the reaction of oxygen reduction at the cathode is in fact more difficult to perform than the hydrogen oxidation reaction at the anode. There is then a tendency to have a cathode capacitance higher than the anode capacitance, which will behave as a limiting agent.

To balance the capacitances at the anode and at the cathode, it is then necessary to increase the capacitance at the anode, for example by increasing the thickness of its layer combining the hydrophilic material and the hydrophobic material. However, such addition causes electrical losses through increase in contact resistance, and limitations on transfer of the reactants owing to the large increase in thickness of the MEA.

The invention aims to solve one or more of these drawbacks. The invention thus relates to a fuel cell as defined in claim 1.

The invention also relates to the variants defined in the dependent claims. A person skilled in the art will understand that each of the features of the variants of the dependent claims may be combined independently with the features of claim 1, but without constituting an intermediate generalization.

Other features and advantages of the invention will become clearer from the description thereof given hereunder, as a guide and in an entirely non-limiting manner, referring to the appended drawings, in which:

FIG. 1 is an exploded perspective view of an example of a stack of membrane/electrode assemblies and bipolar plates for a fuel cell;

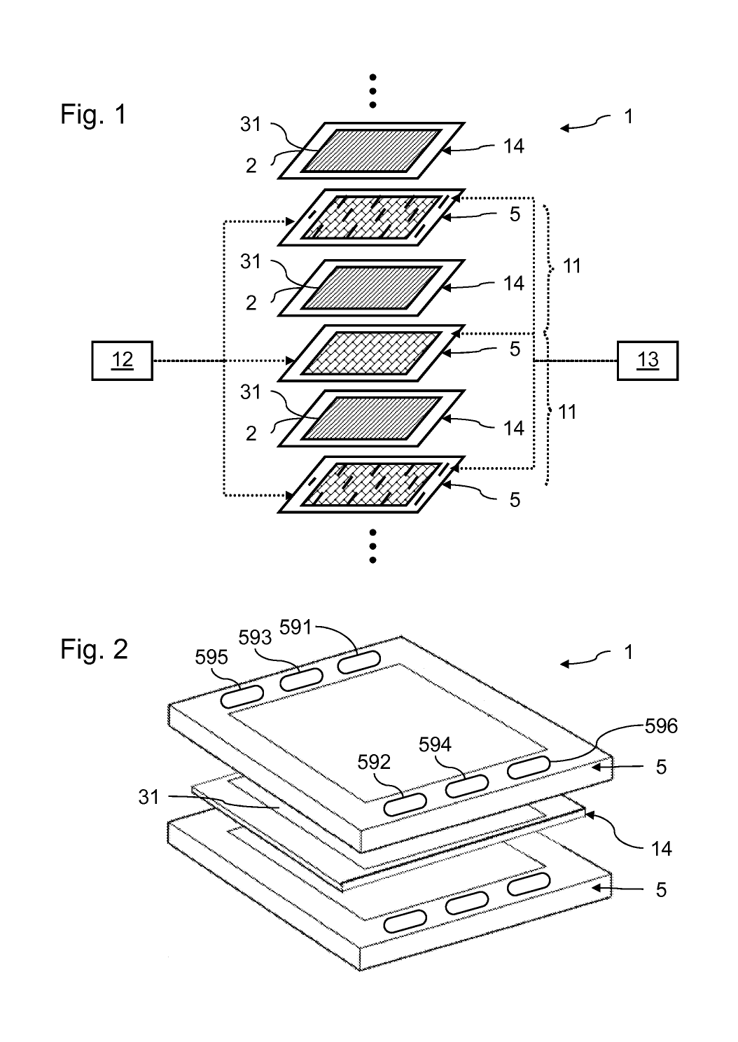

FIG. 2 is an exploded perspective view of bipolar plates and of a membrane/electrode assembly intended to be stacked to form flow collectors through the stack;

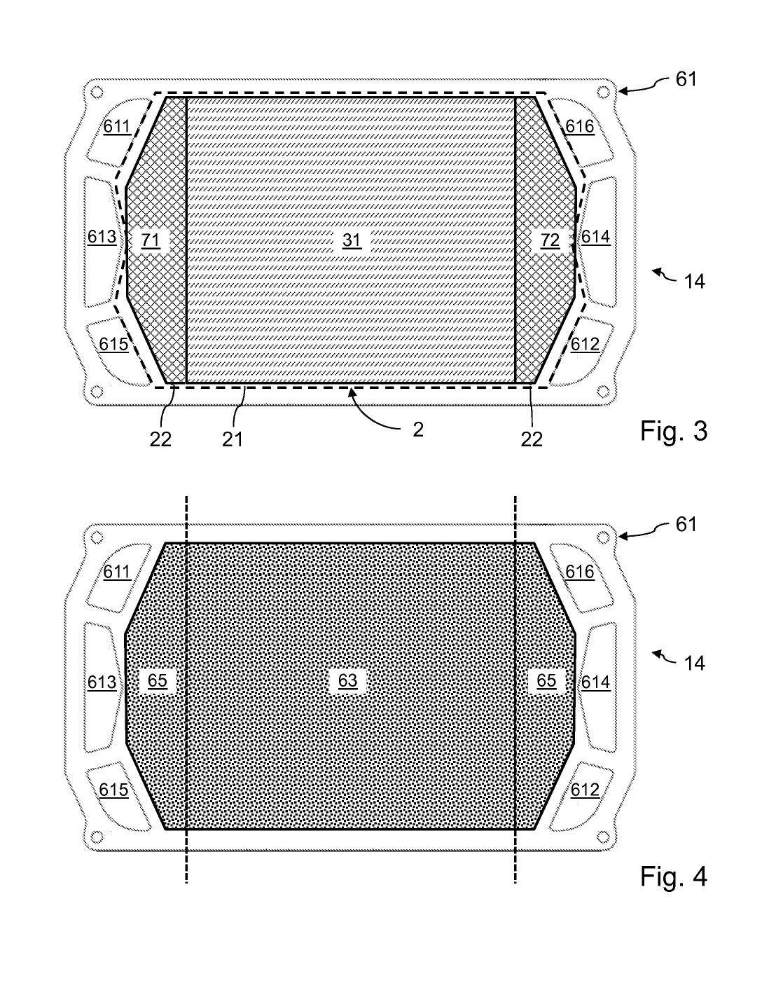

FIGS. 3 and 4 are top views of a membrane/electrode assembly according to an embodiment example of the invention;

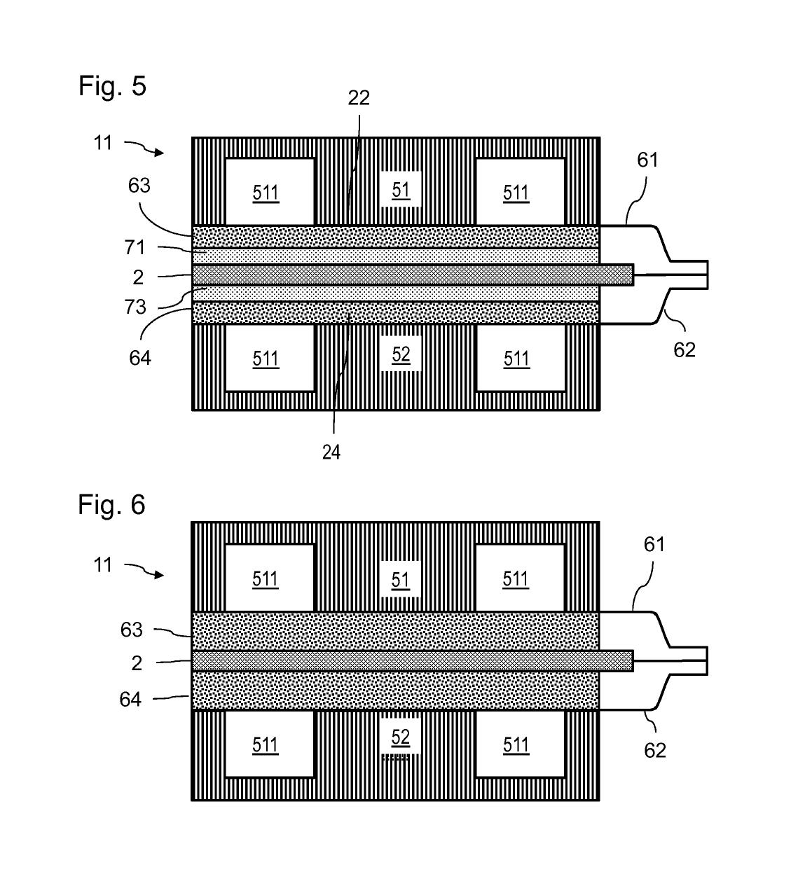

FIG. 5 is a cross-sectional view of a fuel cell including a membrane/electrode assembly according to the embodiment in FIG. 3;

FIG. 6 is a cross-sectional view of a fuel cell including a variant of membrane/electrode assembly;

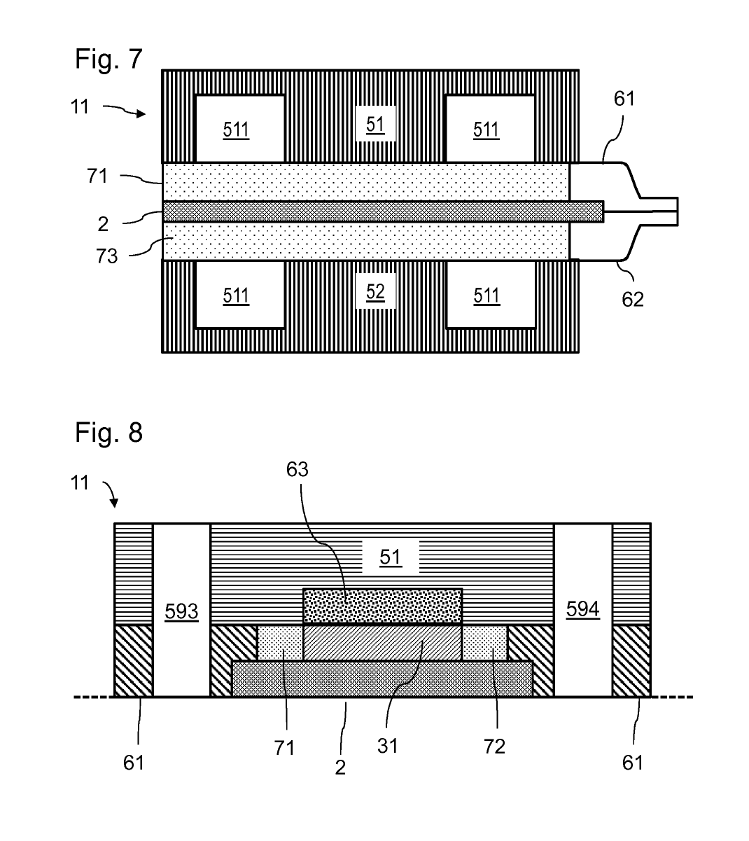

FIG. 7 is a cross-sectional view of a fuel cell including another variant of membrane/electrode assembly;

FIG. 8 is a view in longitudinal section of a fuel cell according to a variation of FIG. 6;

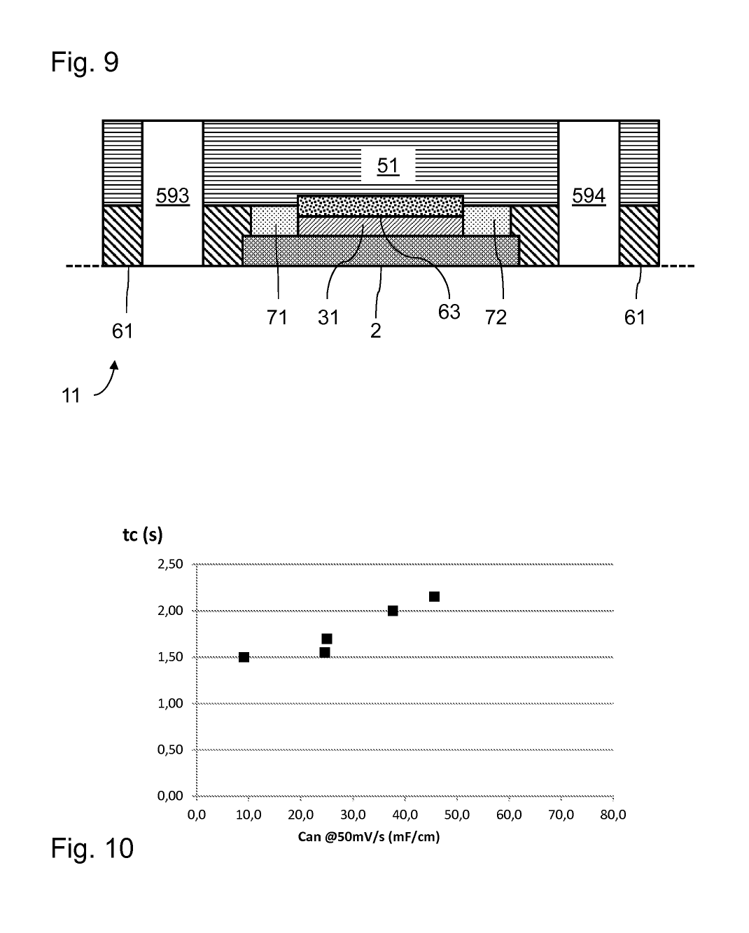

FIG. 9 is a view in longitudinal section of a fuel cell according to another variation of FIG. 6;

FIG. 10 is a diagram illustrating the extinction time of different fuel cells as a function of the structure of their reactive zone;

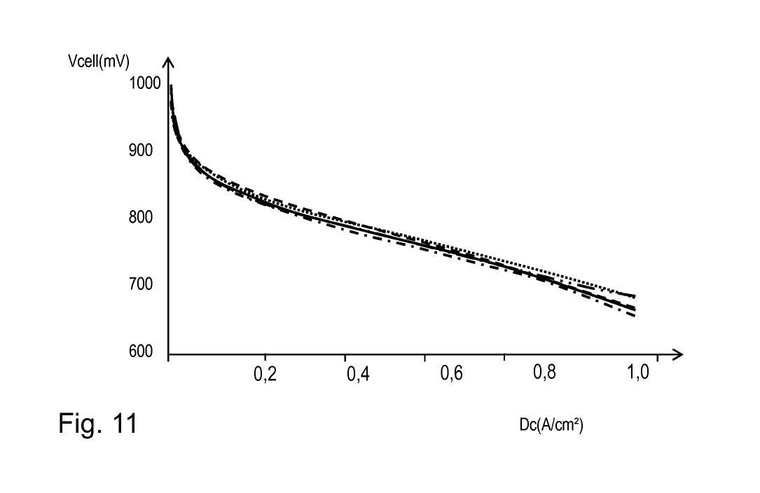

FIG. 11 is a diagram illustrating the performance of different fuel cells as a function of the structure of their reactive zone.

FIG. 1 is a schematic exploded perspective view of a stack of cells 11 of a fuel cell 1. The fuel cell 1 comprises several superposed cells 11. The cells 11 are of the proton exchange membrane or polymer electrolyte membrane type.

The fuel cell 1 comprises a fuel source 12. The fuel source 12 supplies an inlet of each cell 11 with dihydrogen in this case. The fuel cell 1 also comprises a source of combustive 13. The source of combustive 13 in this case supplies air to an inlet of each cell 11, the oxygen of the air being used as oxidant. Each cell 11 also comprises exhaust channels. One or more cells 11 also have a cooling circuit.

Each cell 11 comprises a membrane/electrode assembly 14 or MEA 14. A membrane/electrode assembly 14 comprises an electrolyte or proton exchange membrane 2, an anode 31 and a cathode (not illustrated) placed on either side of the electrolyte and fixed on this electrolyte 2. The layer of electrolyte 2 forms a semipermeable membrane allowing proton conduction while being impermeable to the gases present in the cell. The layer of electrolyte also prevents passage of the electrons between the anode 31 and the cathode.

A bipolar plate 5 is arranged between each pair of adjacent MEAs. Each bipolar plate 5 defines anode flow channels and cathode flow channels. Bipolar plates 5 also define flow channels for liquid coolant between two successive membrane/electrode assemblies.

In a manner known per se, during operation of the fuel cell 1, air flows between an MEA and a bipolar plate 5, and dihydrogen flows between this MEA and another bipolar plate 5. At the anode, dihydrogen is oxidized to produce protons, which pass through the MEA. The electrons produced by this reaction are collected by a bipolar plate 5. The electrons produced are then applied to an electrical load connected to the fuel cell 1 to form an electric current. At the cathode, oxygen is reduced and reacts with the protons to form water. The reactions at the anode and the cathode are written as follows:

H₂→2H⁺+2e⁻at the anode;

4H⁺+4e⁻+O₂→2H₂O at the cathode.

During its operation, a cell of the fuel cell usually generates a DC voltage between the anode and the cathode of the order of 1V.

FIG. 2 is a schematic exploded perspective view of two bipolar plates 5 and of a membrane/electrode assembly intended to be included in the stack of the fuel cell 1. The stack of the bipolar plates 5 and membrane/electrode assemblies 14 is intended to form a plurality of flow collectors, the arrangement of which is only illustrated schematically here. For this purpose, respective holes are made through the bipolar plates 5 and through the membrane/electrode assemblies 14. The MEAs 14 comprise reinforcements (not illustrated) at their periphery.

The bipolar plates 5 thus comprise holes 591, 593 and 595 at a first end, and holes 592, 594 and 596 at a second end opposite the first. Hole 591 serves for example to form a fuel supply collector, hole 592 serves for example to form a collector for evacuating combustion residues, hole 594 serves for example to form a collector for supplying liquid coolant, hole 593 serves for example to form a collector for evacuating liquid coolant, hole 596 serves for example to form a collector for supplying combustive, and hole 595 serves for example to form a collector for evacuating reaction water.

The holes in the bipolar plates 5 and in the membrane/electrode assemblies 14 (i.e. the holes made in the reinforcements, which are not illustrated) are arranged facing one another in order to form the various flow collectors.

FIG. 3 is a top view of a membrane/electrode assembly 14 according to an embodiment example of the invention in the absence of a gas diffusion layer. FIG. 4 is a top view of the membrane/electrode assembly 14 in FIG. 3, provided with a gas diffusion layer 63. FIG. 5 is a cross-sectional view of a cell 11 of a fuel cell, according to an improved version of the invention, at the level of an edge of a linking zone detailed later.

The membrane/electrode assembly 14 includes the membrane 2, an anode 31 and a cathode (not illustrated) integrated on either side of the membrane 2. The membrane/electrode assembly 14 advantageously additionally includes reinforcements 61 and 62. The reinforcements 61 and 62 are fixed at the periphery of respective faces of the membrane 2.

Reinforcement 61 further comprises holes 611, 613 and 615 made alongside a median opening, without a reference number. The holes 611, 613 and 615 are intended to be positioned facing the holes 591, 593 and 595 of the bipolar plates 51 and 52, detailed later. Reinforcement 61 comprises holes 612, 614 and 616 made opposite holes 611, 613 and 615, relative to the median opening. Holes 612, 614 and 616 are intended to be positioned facing holes 592, 594 and 596 of the bipolar plates 51 and 52.

A gas diffusion layer 63 is in contact with the anode 31 through a median hole made through reinforcement 61. A lower gas diffusion layer (not illustrated) is in contact with the cathode through a median hole made through reinforcement 62.

Anode 31 defines an active zone 21 in which the anodic electrochemical reaction takes place. A bipolar plate 51 is opposite the gas diffusion layer 63 and comprises flow channels 511 for guiding fuel such as dihydrogen to the active zone 21. The collector 591 is thus in communication with other flow channels of the bipolar plate 51, made in the active zone. A linking zone or homogenization zone 22 is provided between the active zone 21 and the flow collectors 592, 594 and 596. Another linking zone or homogenization zone 22 is provided between the active zone 21 and the flow collectors 591, 593 and 595. One linking zone 22 is intended in a manner known per se to homogenize the flow of fuel between collector 591 and the anode flow channels, the other linking zone 22 being intended to homogenize the anodic outlet flow. The linking zones 22 begin at the level of the longitudinal ends of the anode 31.

Another bipolar plate 52 is opposite the gas diffusion layer 64 and comprises flow channels for guiding a combustive such as air to the cathode active zone. The cathode defines an active zone in which the cathodic electrochemical reaction takes place. A linking zone or homogenization zone 24 is provided between the cathode active zone and the flow collectors 592, 594 and 596, another linking zone 24 being provided between the cathode active zone and the flow collectors 591, 593 and 595. One linking zone 24 is intended in a manner known per se to homogenize the flow of combustive between the cathode flow channels and the collector 596. The other linking zone 24 is intended in a manner known per se to homogenize the flow between the cathode flow channels and the outlet collector 595. For simplicity, the (optional) flow channels of liquid coolant through the bipolar plates 51 and 52 are not illustrated.

The catalyst loading is normally higher at the cathode than at the anode as the oxygen reduction reaction at the cathode is more difficult to perform than the hydrogen oxidation reaction at the anode. There is then a tendency to have a cathode capacitance higher than the anode capacitance. Inclusion of a capacitive layer under the anode to balance the anodic and cathodic capacitances gives rise to difficulties in the fabrication of an MEA 14 and causes an appreciable increase in electrical losses because of the contact resistances introduced by adding this capacitive layer under the anode. Increase in catalyst loading at the anode may improve the specific capacitance of the anode but proves prohibitive owing to its cost.

According to the invention, the anode 31 has a composition that makes it possible to increase its intrinsic capacitance, without impairing its catalytic performance or increasing its cost excessively.

The composition of the anode 31 comprises a mixture including:
a proton conductor, known per se;
platinum supported on carbon powder, known per se;
additional carbon, not supporting any catalyst, and having a BET specific surface area at least equal to 200 m²/g, i.e. a high specific surface area, advantageously at least equal to 600 m²/g, or even at least equal to 1000 m²/g.

A person skilled in the art has a bias against the use of such carbon with high specific surface area as a catalyst support, as it is reputed to limit gas diffusion and to be particularly sensitive to corrosion. The inventors found, surprisingly, that the use of the mixture including this carbon as additional carbon made it possible to increase the capacitance of the anode appreciably, but without impairing its performance.

The additional carbon could be carbon distributed under the trade references EC600-JD by the company AkzoNobel, or Vulcan by the company Cabot.

Advantageously, the additional carbon advantageously represents a proportion by weight of at least 15% (guaranteeing an optimal electrical capacitance for the anode 31) of the anode 31, and of at most 45% of the anode 31 (so as not to degrade the catalytic performance of the anode 31). Advantageously, the additional carbon is a carbon black powder. Advantageously, the anode 31 includes a weight per surface area of carbon in the mixture at least equal to 0.2 mg·cm⁻², preferably at least equal to 0.3 mg·cm⁻².

The proton conductor may be for example an ionomer such as PFSA, for example distributed under the trade references Nafion by the company Dupont de Nemours or Aquivion by the company Solvay. The proton conductor advantageously represents a proportion by weight of between 25 and 35% of the anode 31.

The platinum supported on carbon powder may for example use carbon powder distributed under the trade reference Vulcan by the company Cabot. Platinum could represent a proportion by weight of between 30 and 50% of the assembly comprising this platinum and its carbon powder support. The platinum and its carbon powder support advantageously represent a proportion by weight at least equal to 30% of the anode 31. To keep the cost price low, the weight per surface area of platinum of the anode 31 is advantageously at most equal to 0.15 mg·cm⁻², preferably at most equal to 0.1 mg·cm⁻².

For an optimal balance of the capacitances of the anode and cathode, the anode 31 will advantageously be dimensioned so that its capacitance is at least equal to 65% of the capacitance of the cathode.

Tests were carried out with different compositions of the mixture of the anode 31.

A first composition of mixture for an anode 31 of a membrane/electrode assembly 14 according to the invention is as follows:

| | | % dry | % dry |
|---|---|---|---|
| | | matter in | matter in the |
| | | the ink | composition |
| | | before | of the anode |
| | Weight (g) | drying | obtained |
| Catalyst distributed by Tanaka | 4.00 | 9% | 23.26% Pt + |
| under trade reference | | | 25.92% Carbon |
| TEC10V50E | | | |
| Dispersion of ionomer of trade | 9.60 | 21% | 26.23% |
| reference Nafion D2020 | | | |
| Additional carbon with high | 2.00 | 4% | 24.59% |
| specific surface area, of trade | | | |
| reference | | | |
| Ketjenblack EC600-JD | | | |
| Ethanol | 2.25 | 5% | 0.0% |
| Distilled water | 27.75 | 61% | 0.0% |

Such an ink composition made it possible to obtain a membrane/electrode assembly 14 with an anode 31 comprising a loading of 0.103 mg·cm⁻² of platinum and 0.109 mg·cm⁻² of additional carbon with high specific surface area.

A second composition of mixture for an anode 31 of a membrane/electrode assembly 14 according to the invention is as follows:

| | | % dry | % dry |
|---|---|---|---|
| | | matter in | matter in the |
| | | the ink | composition |
| | | before | of the anode |
| | Weight (g) | drying | obtained |
| Catalyst distributed by Tanaka | 2.60 | 6% | 15.12% Pt + |
| under trade reference | | | 16.82% Carbon |
| TEC10V50E | | | |
| Dispersion of ionomer of trade | 9.60 | 21% | 26.23% |
| reference Nafion D2020 | | | |
| Additional carbon with high | 3.40 | 7% | 41.80% |
| specific surface area, of trade | | | |
| reference | | | |
| Ketjenblack EC600-JD | | | |
| Ethanol | 2.25 | 5% | 0.0% |
| Distilled water | 27.75 | 61% | 0.0% |

Such an ink composition made it possible to obtain a membrane/electrode assembly 14 with an anode 31 comprising a loading of 0.101 mg·cm⁻² of platinum and 0.297 mg·cm⁻² of additional carbon with high specific surface area.

A third composition of mixture for an anode 31 of a membrane/electrode assembly 14 according to the invention is as follows:

| | | % dry | % dry |
|---|---|---|---|
| | | matter in | matter in the |
| | | the ink | composition |
| | | before | of the anode |
| | Weight (g) | drying | obtained |
| Catalyst distributed by Tanaka | 17 | 4.6% | 12.21% Pt + |
| under trade reference | | | 13.61% Carbon |
| TEC10V50E | | | |
| Dispersion of ionomer of trade | 77.71 | 20.9% | 26.23% |
| reference Nafion D2020 | | | |
| Additional carbon with high | 31.57 | 8.5% | 47.95% |
| specific surface area, of trade | | | |
| reference | | | |
| Vulcan XC-72 | | | |
| Ethanol | 21 | 5.6% | 0.0% |
| Distilled water | 224.64 | 60.4% | 0.0% |

Such an ink composition made it possible to obtain a membrane/electrode assembly 14 with an anode 31 comprising a loading of 0.079 mg·cm⁻² of platinum and 0.398 mg·cm⁻² of additional carbon with high specific surface area.

The preceding ink compositions all have a proportion of dry matter at least equal to 15 wt %.

A first reference anode was used for comparison, starting from an ink with the following composition:

| | | % dry | % dry |
|---|---|---|---|
| | | matter in | matter in the |
| | | the ink | composition |
| | | before | of the anode |
| | Weight (g) | drying | obtained |
| Catalyst distributed by Tanaka | 6 | 13% | 21.39% Pt + |
| under trade reference | | | 52.38% Carbon |
| TEC10V30E | | | |
| Dispersion of ionomer of trade | 9.6 | 21% | 26.23% |
| reference Nafion D2020 | | | |
| Ethanol | 212.25 | 5% | 0.0% |
| Distilled water | 27.75 | 61% | 0.0% |

Such an ink composition made it possible to obtain a membrane/electrode assembly with an anode comprising a loading of 0.098 mg·cm⁻² of platinum.

A second reference anode was used for comparison, starting from an ink with the following composition:

| | | % dry | % dry |
|---|---|---|---|
| | | matter in | matter in the |
| | | the ink | composition |
| | | before | of the anode |
| | Weight (g) | drying | obtained |
| Catalyst distributed by Tanaka | 5 | 13% | 22.28% Pt + |
| under trade reference | | | 51.49% Carbon |
| TEC10EA30E-HT | | | |
| Dispersion of ionomer of trade | 8 | 21% | 26.23% |
| reference Nafion D2020 | | | |
| Ethanol | 0 | 0% | 0.0% |
| Distilled water | 1.88 | 61% | 0.0% |

Such an ink composition made it possible to obtain a membrane/electrode assembly with an anode comprising a loading of 0.125 mg·cm⁻² of platinum.

In a first experiment, 500 mg of each electrode (with a carbon support) was cut finely, among the first to third compositions according to the invention and the first and second reference electrodes. Measurements of adsorption/desorption of gas were then performed at 77K (using apparatus distributed under the trade reference Tristar II by the company Micromeritics). The BET specific surface areas obtained for the different electrodes are reported in the following table and compared with the BET specific surface areas of certain carbons with high specific surface area.

| Material | Active surface (m² · g⁻¹) |
|---|---|
| First composition of mixture of the invention | 38.6 ± 0.9 |
| Second composition of mixture of the invention | 47.4 ± 0.8 |
| Third composition of mixture of the invention | 26.5 ± 3.5 |
| Reference electrode 1 | ≈26 |
| Reference electrode 2 | ≈18.5 |
| Carbon with high specific surface area of trade | ≈220 |
| reference Vulcan XC-72 | |
| Carbon with high specific surface area of trade | ≈1400 |
| reference Ketjenblack EC600-JD | |

For the first and second compositions of mixtures, having an additional carbon with little graphite, the BET specific surface area of the anode 31 obtained is relatively high. For the third composition of mixture, with an additional carbon having more graphite, the BET specific surface area is lower.

In a second experiment, each electrode among the first to third compositions according to the invention and the first and second reference electrodes were fixed to a membrane/electrode assembly by hot pressing at 135° C. The membrane selected is distributed under the trade reference Gore-Tex 735.18MX. The cathode of the assembly was identical in all cases, namely including a catalyst distributed under the trade reference Tanaka TEC36V52 at 34.6 wt % of platinum finally, 39.17 wt % of platinum support carbon finally, and 26.23 wt % of an ionomer Nafion D2020 finally (with a capacitance of 63 mF·cm⁻²).

Cyclic voltammetry measurements were carried out for each assembly, with a scan rate of 50 mV·s⁻¹. The capacitance Cₐₙ of the anodes was calculated according to the following formula:

Cₐₙ(mF·cm⁻²)=Jₐₙ(mA·cm⁻²)/v(V·s⁻¹)

where Jₐₙ is the current density associated with the capacitive process of energy storage, measured at 450 mV, and v is the scan rate.

| Anode | Cₐₙ (mF · cm⁻²) |
|---|---|
| First composition of mixture of the invention | 38.2 |
| Second composition of mixture of the invention | 46.1 |
| Third composition of mixture of the invention | 39.2 |
| Reference electrode 1 | 27.2 |
| Reference electrode 2 | 9.0 |

In a third experiment, each membrane/electrode assembly from the second experiment was tested in shortage of air. For this purpose, the flow of air to the cathode was stopped, leading to depolarization of the cell. The energy stored in the capacitances of the anode and of the cathode makes it possible to maintain the polarization of the cell transiently. The length of time this is maintained corresponds to an extinction time, i.e. the difference between the instant when the flow is stopped and the moment when the cell potential falls below a threshold, fixed arbitrarily at a value of 400 mV in the present case. FIG. 10 illustrates the extinction times (or falling time tc) for the different membrane/electrode assemblies, by illustrating the link with their anode capacitance (corresponding to the second experiment). The results clearly illustrate the lengthening of the extinction time with the increase in capacitance of the anode 31 permitted by the invention.

The electrochemical performance of the different membrane/electrode assemblies (first to third compositions of mixture according to the invention, first and second reference anodes) are illustrated in FIG. 11. FIG. 11 shows the cell voltage Vcell on the ordinate, and the current density Dc on the abscissa. The curve shown with a dotted line corresponds to the first reference anode. The curve with double dot and dash corresponds to the second reference anode. The curve with a solid line corresponds to the first anode composition according to the invention. The dot-and-dash curve corresponds to the second anode composition according to the invention.

The curve shown as a broken line corresponds to the third anode composition according to the invention. The performance was obtained for current densities below 1 Å·cm⁻² with relative humidity of 70%, a temperature of 70° C. and a pressure of 1.4 bar.

It can be seen that the performance levels of the different membrane/electrode assemblies are very similar over the entire operating range of the cell. Thus, the modifications of the anode 31 do not affect the cell voltage significantly in normal operation. Increase in capacitance of an anode 31 according to the invention therefore does not impair the electrochemical performance of a fuel cell. Moreover, in the absence of addition of an additional layer to the anode 31, addition of a corresponding contact resistance is avoided.

The anode 31 may be applied to the membrane in the form of an ink including these components, for example by printing. Besides these components, the ink will include a solvent such as water or ethanol. The proportions by weight indicated correspond to a dry anode 31, after removing the solvent. The ink will include a percentage by weight of dry matter preferably at least equal to 15%. Other methods such as coating, screen printing or spraying can be used.

According to another alternative, the anode 31 may be formed on the gas diffusion layer 63, for example by coating.

To facilitate manufacture of the ink, the additional carbon with high specific surface area is advantageously added to the solvent first. The inks including the different components of the mixtures are advantageously homogenized using a mixer.

According to an improved version of the invention, the membrane/electrode assembly 14 further comprises a capacitive layer 71 on a linking zone 22, and a capacitive layer 72 on another linking zone 22. Advantageously, the capacitive layers 71 and 72 occupy the major part of the surface of their respective linking zone 22, in order to optimize the integrated capacitance in the fuel cell 1.

The capacitive layers 71 and 72 are in electrical contact with the bipolar plate 51, so as to be able to discharge/recharge as needed. For an optimal capacitance, the capacitive layers 71 and 72 include a mixture of carbon having a BET specific surface area at least equal to 200 m²/g and a proton-conducting material, advantageously at least equal to 500 m²/g, or even at least equal to 700 m²/g. Such a carbon has a high specific surface area so as to be able to store a maximum of electric charges. The proton-conducting material is intended to promote transport of protons to the sites for storage of the electric charges in the carbon.

Implantation of a capacitive layer on an anodic linking zone of the membrane 14 makes it possible to produce this capacitive layer without compromising the structure and the performance of the anode 31.

The carbon of the mixture may be for example carbon black distributed under the trade reference Ketjenblack CJ300 by the company Lion Speciality Chemicals, or the carbon black distributed under the trade reference Acetylene Black AB50X GRIT by the company Chevron Phillips Chemical.

The proton conductor of the mixture may be for example a proton-conducting binder, for example PFSA as marketed under the trade references Nafion, Aquivion or Flemion, PEEK, or polyamine.

The mixture of the capacitive layers 71 and 72 advantageously has a proportion by weight of this carbon at least equal to 40%, preferably at least equal to 55%. Advantageously the proportion by weight of this carbon is at most equal to 80%, or even at most equal to 65%. The mixture of the capacitive layers 71 and 72 advantageously has a proportion by weight of the proton conductor at least equal to 20%, preferably at least equal to 35%. Advantageously the proportion by weight of the proton conductor is at most equal to 60%, or even at most equal to 45%.

In the example illustrated, the gas diffusion layer 63 comprises portions 65 overflowing longitudinally on either side relative to the reactive zone 21. These portions 65 cover the capacitive layer 71 and the capacitive layer 72, respectively.

The capacitive layers 71 and 72 advantageously have a thickness of between 10 and 50 nm in the configuration illustrated in FIGS. 3 to 5.

The capacitive layers 71 and 72 will advantageously be dimensioned to have a surface capacitance at least equal to 600 mF/cm².

The capacitive layers 71 and 72 are advantageously free from catalyst material, for example free from any catalyst material present in the anode 31.

Here, the membrane/electrode assembly 14 further comprises a capacitive layer 73 on the linking zone 24. Advantageously, another capacitive layer covers another linking zone produced on the membrane 2, disposed opposite to the linking zone 24 relative to the cathode.

Advantageously, these capacitive layers of the cathodic side occupy the major part of the surface of their respective linking zone, in order to optimize the integrated capacitance in the fuel cell 1.

In order to have a good balance of the capacitive layers of the anodic side and cathodic side, the capacitive layers of the cathodic side advantageously have the same composition, the same thickness, and/or the same geometry as the capacitive layers on the anodic side. The anodic capacitive layers and the cathodic capacitive layers are superposed here.

The electrode 31 and/or the capacitive layers 71 and 72 may be produced by applying inks to the membrane 2, for example by coating, screen printing or spraying.

FIG. 6 is a sectional view of a cell 11 of a fuel cell, including a variant of membrane/electrode assembly 14, at the level of an edge of a linking zone. The membrane/electrode assembly 14 includes the same structure of membrane 2, of anode and of cathode, of reinforcements 61 and 62 and of bipolar plates 51 and 52 as in the variant in FIG. 3. In this variant, the gas diffusion layers 63 and 64 have the same geometry as in the variant in FIG. 3. The mixture of carbon and of proton conductor is included here in the parts of the gas diffusion layers 63 and 64 that cover the linking zones. The mixture may for example be included in the gas diffusion layers 63 and 64 by impregnation. The gas diffusion layers 63 and 64 advantageously do not include the mixture in their median zone covering their reactive zone. The gas diffusion layers 63 and 64 may have a thickness of between 150 and 300 nm for example.

According to this variant, a capacitive layer may be included directly above a linking zone, without increasing the thickness of the stack at the level of this linking zone.

FIG. 7 is a sectional view of a cell 11 of a fuel cell, including another variant of membrane/electrode assembly 14, at the level of an edge of a linking zone. The membrane/electrode assembly 14 includes the same structure of membrane 2, of anode and of cathode, of reinforcements 61 and 62 and of bipolar plates 51 and 52 as in the variant in FIG. 3. In this variant, the gas diffusion layers 63 and 64 cover the anode 31 and the cathode, respectively. In this variant, the gas diffusion layers 63 and 64 do not extend as far as the linking zones, and therefore do not cover these linking zones.

Here, the mixture of carbon and of proton conductor forms a layer, which extends continuously between the membrane 2 and their respective bipolar plate 51 or 52. Such a mixture layer may typically have a thickness of between 40 and 150 nm.

According to this variant, it is possible to avoid extending the gas diffusion layers into the linking zones.

FIG. 8 is a view in longitudinal section of the upper part of a cell 11 according to another variation of the variant in FIG. 7. In this variation, the capacitive layers 71 and 72 have a thickness equal to that of the anode 31, and therefore less than the cumulative thickness of the anode 31 and gas diffusion layer 63. The bipolar plate 51 thus has a raised zone facing a linking zone, in order to compensate this difference in thickness.

FIG. 9 is a view in longitudinal section of the upper part of a cell 11 according to a variation of the variant in FIG. 7. In this variation, the capacitive layers 71 and 72 have a thickness greater than that of the anode 31, but less than the cumulative thickness of the anode 31 and gas diffusion layer 63. The bipolar plate 51 thus has a raised zone facing a linking zone, in order to compensate this difference in thickness.

Although an embodiment has been described with capacitive layers in the linking zones on either side of the anode, we may also envisage only producing a capacitive layer in a linking zone on one side of the anode.

1. A fuel cell, comprising:
a membrane/electrode assembly, comprising:
a proton exchange membrane;
an anode in contact with a first face of the membrane and comprising a mixture comprising a proton conducting polymer and platinum supported on carbon powder;
said mixture further comprising additional carbon not supporting a catalyst and having a BET specific surface area at least equal to 200 m²/g;
wherein the membrane/electrode assembly comprises a first active zone covered by the anode, and a first linking zone not covered by said anode;
the fuel cell further comprising flow guiding plates, between which the membrane/electrode assembly is arranged, said flow guiding plates being traversed by at least one first flow collector in communication with said anode, said first linking zone being arranged between said first flow collector and the first active zone;
wherein the membrane/electrode assembly further comprises a first capacitive layer comprising another mixture comprising carbon having a BET specific surface area at least equal to 200 m²/g and a proton-conducting material, said first capacitive layer being arranged on said first linking zone.

2. The fuel cell as claimed in claim 1, wherein said additional carbon has a BET specific surface area at least equal to 600 m²/g.

3. The fuel cell as claimed in claim 1, wherein said additional carbon comprises a carbon black powder.

4. The fuel cell as claimed in claim 1, wherein said mixture comprises said additional carbon with a proportion by weight at least equal to 15%.

5. The fuel cell as claimed in claim 1, wherein said mixture comprises said additional carbon with a proportion by weight at most equal to 45%.

6. The fuel cell as claimed in claim 1, wherein said anode has a BET specific surface area at least equal to 35 m²/g.

7. The fuel cell as claimed in claim 1, further comprising a cathode, the capacitance of the anode being at least equal to 65% of the capacitance of the cathode.

8. The fuel cell as claimed in claim 1, wherein the anode comprises a weight per surface area of platinum at most equal to 0.15 mg·cm⁻².

9. The fuel cell as claimed in claim 1, wherein the anode comprises a weight per surface area of additional carbon in the mixture at least equal to 0.1 mg·cm⁻².

10. The fuel cell as claimed in claim 1, further comprising a gas diffusion layer positioned between said anode and one of said flow guiding plates, said gas diffusion layer comprising a portion covering said first linking zone, said portion of the gas diffusion layer comprising said other mixture of proton-conducting material and of carbon.

11. The fuel cell as claimed in claim 10, wherein said gas diffusion layer does not cover said first linking zone, said other mixture of proton-conducting material and of carbon extending continuously between said membrane and one of said flow guiding plates.

12. The fuel cell as claimed in claim 1 said first capacitive layer comprises a proportion by weight of said proton-conducting material of between 20 and 60%, and a proportion by weight of said carbon of between 40 and 80%.

13. The fuel cell as claimed in claim 1 said first capacitive layer lacks catalyst.

14. The fuel cell as claimed in claim 1, wherein the membrane/electrode assembly comprises a reinforcing layer integral with the membrane and surrounding said first capacitive layer.
